(19) United States
(12) Patent Application Publication
(10) Pub. No.: US 2008/0121796 A1
(43) Pub. Date: May 29, 2008

(54) Mass Spectrometer

(75) Inventors: Martin Green, Cheshire (GB); Robert Harold Bateman, Cheshire (GB)

Correspondence Address: WATERS INVESTMENTS LIMITED;C/O WATERS CORPORATION, 34 MAPLE STREET - LG, MILFORD, MA, 01757, US

(73) Assignee: MICROMASS UK LIMITED, Manchester (GB)

(21) Appl. No.: 11/568,347

(22) PCT Filed: Apr. 26, 2005
(86) PCT No.: PCT/GB05/01585

§ 371 Date: Sep. 4, 2007

Related U.S. Application Data
(60) Provisional application No. 60/587,053, filed on Jul. 13, 2004.

(30) Foreign Application Priority Data
Apr. 26, 2004 (GB) 0409118.7

(51) Int. Cl. H01J 49/02

(52) U.S. Cl. 250/283; 250/281

(57) ABSTRACT

An ion detector for a mass spectrometer is provided wherein a mask (10) is provided between a first microchannel plate (2a) and a second microchannel plate (2b). The mask (10) prevents ion arrival events causing a cloud of secondary electrons to be from the second microchannel plate (2b) which would illuminate two collection anodes (5,6) at substantially the same time. The mask (10) also prevents electron clouds emitted which would otherwise vary significantly in intensity.

The present invention relates to an ion detector, a mass spectrometer, a method of detecting ions and a method of mass spectrometry.

Various different types of detectors for detecting and recording individual electrons, ions or photons are known. A particular type of an ion detector is known wherein ions impinge upon one or more microchannel plates (“MCPs”) causing secondary electrons to be released and amplified. A pulse of electrons emitted from a microchannel plate arrives at a collection anode and is counted using a fast electronic event counter. Such ion detectors are commonly used in Time of Flight (“TOF”) mass analysers in mass spectrometers for detecting and recording individual ions and their arrival times.

It is known that the maximum count rate for such known ion detectors can be increased by using multiple collection anodes each with its own fast electronic event counter rather than a single collection anode. Ion detectors employing multiple collection anodes are used, for example, in Time of Flight mass analysers to extend the dynamic range of the mass analyser. The collection anodes are arranged to collect and record different fractions or groups of the secondary electron pulses produced due to ions arriving at the input to the detector system. Each collection anode is attached to its own separate amplifier, discriminator and Time to Digital Converter (TDC).

Once the ion arrival rate at the input of a known electron multiplier detector system exceeds a certain limit then the signal recorded from the larger of the two collection anodes will become increasingly inaccurate. Accordingly, the ion arrival event counter will begin to miss counts. However, the signal recorded from the smaller collection anode arranged to detect and record the smaller fraction of secondary electron pulses will continue to count all the ions arriving at the corresponding input area of the microchannel plate. If the ratio between the fractions of ion arrival events recorded on the different collection anodes is known, then the overall ion arrival rate can be calculated. Accordingly, the dynamic range for quantification of the arriving ion current can be extended.

In a Time of Flight mass spectrometer missed ion counts will lead to a shift in the recorded ion arrival distribution for ions having a specific mass to charge ratio. This will lead to a shift in the measured mean arrival time of the ions and consequently an error in the determination of their mass to charge ratio will be introduced. If the dynamic range of the ion detector is increased then the accuracy of both the quantification of the ion signal and the determination of the mass to charge ratio of the corresponding ions may be increased.

It is contemplated that the dynamic range of an ion counting detector could be improved by providing a mask to attenuate the number of secondary electron pulses arriving at one of the collection anodes. It is contemplated that the mask could be positioned either downstream of the final microchannel plate to prevent some secondary electrons from impinging upon one of the collection anodes or alternatively the mask could be provided upstream of the first microchannel plate in order to reduce the intensity of ions impinging upon the microchannel plates. In any event, the two collection anodes are arranged to collect different fractions of the secondary electron pulses emitted from the microchannel plates.

One problem with these contemplated arrangements is that for each ion arrival the resulting cloud of secondary electrons arriving at the collection anodes will be quite broad. If an ion arrives at a microchannel plate at a position close to the edge of one of the collection anodes in a multiple anode detector system then it is likely that only some or a portion of the secondary electrons generated by an ion arrival will subsequently strike the particular collection anode. However, the number of electrons striking a collection anode will largely determine whether or not an ion arrival is detected and counted. The likelihood of an ion arrival event being recorded will therefore depend upon the position of the ion when it strikes the detector, the electron amplification factor in an electron multiplier, the proportion of electrons in an resultant electron cloud which strikes a collection anode, the amplifier gain and the event counter discriminator level.

The electron amplification factor in an electron multiplier varies from event to event usually according to a Gaussian distribution. An ion counting system is normally designed such that the normal (Gaussion) variation in the electron amplification factor is not sufficient to significantly affect the number of ions counted, whilst any noise in the system is not sufficient to trigger superfluous counts. However, it will be apparent that when ions arrive at a position on the ion detector that corresponds to a boundary of a collection anode then it may not be so cleanly differentiated from noise and the number of counts due to ions which arrive at such positions on the ion detector will vary directly with the settings of the detector system.

An additional significant problem is that, if two collection anodes are arranged in sufficiently close proximity to one another, then a cloud of secondary electrons produced by a single ion arrival at the input of an ion detector may be partially incident upon both the collection anodes. This may result in either the ion arrival event not being counted, or else the ion arrival event may be counted once or twice by the two collection anodes. The extent to which this may happen will vary directly with the settings of the detector system.

The inaccuracies resulting from this effect would be particularly significant for a collection anode arranged to record the smaller fraction of secondary electrons. In some designs, the smaller collection anode may be, for example, one tenth or one hundredth of the area of the larger collection anode. The significance of this error therefore becomes correspondingly greater the smaller the relative area of the smallest collection anode becomes. Furthermore, in some designs of ion detector a collection anode may have a very large edge or boundary relative to its area. For example, one collection anode may comprise a large plate whilst another collection anode may comprise a fine wire positioned in front of the large plate. The fine wire collection anode will have a very large boundary in proportion to its area. Accordingly, the ion detector may suffer from significant errors in the ion count rate recorded by the smaller wire collection anode. This error will be present in the determination of the overall ion count rate for the situation when the overall ion count rate is too high to be accurately recorded on the larger anode.

A particular problem associated with ions arriving at a position corresponding to the boundary between collection anodes is that of shared signals. Some ions may produce electron clouds that strike more than one collection anode. These shared electron clouds will produce smaller signals on each separate collection anode and hence neither may be large enough to be counted.

It is contemplated that a mask may be provided after the final microchannel plate and before the collection anode with the intention of blocking those electron clouds that would otherwise be shared between two collection anodes from reaching either collection anode. However, such an arrangement suffers from the problem that only a part or portion of an electron cloud may strike a particular collection anode. Since the intensity of the cloud of electrons striking the collection anode is reduced this may or may not be sufficient to be registered as an ion arrival event. This will depend on the electron amplification factor in the electron multiplier, the proportion of the electron cloud that strikes the collection anode, the amplifier gain and the detector discriminator level.

The proportion of ions arriving at a position near the edge of the mask that will be detected will vary directly with the settings of the detector system. For a small anode with a large boundary, such as a fine wire collection anode, this may introduce a significant error to the number of ions counted.

It is contemplated that a mask may be provided upstream of the front face of the first microchannel plate with the intention of blocking those ions from reaching the ion detector that would otherwise yield a cloud of electrons that would be shared between two collection anodes. Such a contemplated arrangement does not suffer from the same problems as described above when a mask is provided downstream of the final microchannel plate detector. However, such an arrangement would require a mask to be mounted in front of the front surface of the first microchannel plate and would cause a number of different problems.

Firstly, if such a detector were to be used in a Time of Flight mass spectrometer then some ions having a certain mass to charge ratio will strike the detector surface before others depending upon whether they strike the microchannel plate input face or the mask. Ions striking the edge of the mask may also cause secondary electrons to be released which will then be amplified by the microchannel plates and hence will be subsequently detected giving rise to ghost peaks in the resulting mass spectrum.

Secondly, in some designs of ion detector, such as in post acceleration ion detectors, ions are still being accelerated as they approach the ion detector. If the front face of the microchannel plate arranged to receive ions is not perfectly flat then the accelerating electric field will also not be perfectly uniform. As a result if a mask is provided on the front face of the first microchannel plate then some ions may be accelerated differently to others causing some ions to be deflected and hence arriving at the ion detector at slightly different times. This will result in the broadening of mass peaks in a resulting mass spectrum.

Thirdly, any mask which is intentionally arranged so as to be bombarded by ions may become coated over a period of time with material that may be insulating. As a result, the mask may begin to hold a charge thereby further disturbing the flight path and arrival times of ions. The mask may also be bombarded by incoming ions causing sputtering of secondary atoms and ions, some of which may be subsequently detected by the detector giving rise to ghost peaks in the resulting mass spectrum.

According to an aspect of the present invention there is provided an ion detector comprising:

a first microchannel plate device;

a second microchannel plate device;

a mask or shield provided intermediate between the first microchannel plate device and second microchannel plate device; and

at least a first collection anode having a first active electron detecting area or size and a second separate collection anode having a second different active electron detecting area or size arranged downstream of the second microchannel plate device.

According to an embodiment, the second active electron detecting area or size is equal to a percentage x of the first active electron detecting area or size, wherein x is selected from the group consisting of: (i) <0.2%; (ii) 0.2-0.3%; (iii) 0.3-0.4%; (iv) 0.4-0.5%; (v) 0.5-0.6%; (vi) 0.6-0.7%; (vii) 0.7-0.8%; (viii) 0.8-0.9%; (ix) 0.9-1.0%; (x) 1-10%; (xi) 10-20%; (xii) 20-30%; (xiii) 30-40%; (xiv) 40-50%; (xv) 50-60%; (xvi) 60-70%; (xvii) 70-80%; (xviii) 80-90%; (xix) 90-100%.

The first microchannel plate device may comprise one, two or more than two microchannel plates. Similarly, the second microchannel plate device may comprise one, two or more than two microchannel plates.

The mask or shield is preferably arranged to block, attenuate, at least partially attenuate or divert electrons emitted from the first microchannel plate device. Preferably, the mask or shield substantially prevents electrons exiting from or emerging from the first microchannel plate device and/or from impinging upon or arriving at the second microchannel plate device. According to an embodiment the mask or shield is arranged such that at least some ions arriving at the first microchannel plate device at certain locations or positions on the first microchannel plate device are either: (a) substantially prevented from subsequently causing a cloud of secondary electrons to be emitted from the second microchannel plate device; or (b) subsequently cause a cloud of secondary electrons to be emitted from the second microchannel plate device which either substantially impinge upon the first collection anode or upon the second collection anode but wherein the cloud of secondary electrons emitted from the second microchannel plate device do not substantially impinge simultaneously upon both the first collection anode and the second collection anode.

According to an embodiment the mask or shield is arranged such that ions arriving at the first microchannel plate device do not substantially result in a cloud of secondary electrons being produced which impinges simultaneously upon both the first collection anode and the second collection anode. Preferably, the mask or shield is arranged such that ions arriving at the first microchannel plate device result in a cloud of secondary electrons which impinges either upon the first collection anode or upon the second collection anode but not upon both the first and second collection anodes simultaneously.

According to an embodiment the mask or shield has a thickness selected from the group consisting of: (i) <1 μm; (ii) 1-5 μm; (iii) 5-10 μm; (iv) 10-15 μm; (v) 15-20 μm; (vi) 20-25 μm; (vii) 25-30 μm; (viii) 30-35 μm; (ix) 35-40 μm; (x) 40-45 μm; (xi) 45-50 μm; (xii) 50-55 μm; (xiii) 55-60 μm; (xiv) 60-65 μm; (xv) 65-70 μm; (xvi) 70-75 μm; (xvii) 75-80 μm; (xviii) 80-85 μm; (xix) 85-90 μm; (xx) 90-95 μm; (xxi) 95-100 μm; and (xxii) >100 μm.

Preferably, at least the front face of the first microchannel plate device is maintained, in use, at a voltage or potential selected from the group consisting of: (i) 0 V; (ii) ±0-10 V; (iii) ±10-100 V; (iv) ±100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV. Preferably, at least the rear face of the first microchannel plate device is maintained, in use, at a voltage or potential selected from the group consisting of: (i) 0 V; (ii) ±0-10 V; (iii) ±10-100 V; (iv) ±100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV. Preferably, a potential difference is maintained, in use, across the first microchannel plate device selected from the group consisting of: (i) 0 V; (ii) ±0-10 V; (iii) ±10-100 V; (iv) ±100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV.

According to an embodiment at least the front face of the mask or shield is maintained, in use, at a voltage or potential selected from the group consisting of: (i) 0 V; (ii) ±0-10 V; (iii) ±10-100 V; (iv) ±100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV. Preferably, at least the rear face of the mask or shield is maintained, in use, at a voltage or potential selected from the group consisting of: (i) 0 V; (ii) ±0-10 V; (iii) ±10-100 V; (iv) ±100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV. Preferably, a potential difference is maintained, in use, across the mask or shield selected from the group consisting of: (i) 0 V; (ii) ±0-10 V; (iii) ±10-100 V; (iv) ±100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV.

According to an embodiment at least the front face of the second microchannel plate device is maintained, in use, at a voltage or potential selected from the group consisting of: (i) 0 V; (ii) ±0-10 V; (iii) ±10-100 V; (iv) ±100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV. Preferably, the rear face of the second microchannel plate device is maintained, in use, at a voltage or potential selected from the group consisting of: (i) 0 V; (ii) ±0-10 V; (iii) ±10-100 V; (iv) ±100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV. Preferably, a potential difference is maintained, in use, across the second microchannel plate device selected from the group consisting of: (i) 0 V; (ii) ±0-10 V; (iii) ±10-100 V; (iv) ±100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV.

According to an embodiment a potential difference is maintained, in use, between the rear surface of the first microchannel plate device and the front surface of the mask or shield selected from the group consisting of: (i) 0 V; (ii) ±0-10 V; (iii) ±10-100 V; (iv) 1100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV. Similarly, according to an embodiment a potential difference is maintained, in use, between the rear surface of the mask or shield and the front surface of the second microchannel plate device selected from the group consisting of: (i) 0 V; (ii) ±0-10 V; (iii) ±10-100 V; (iv) ±100-500 V; (v) ±500-1000 V; (vi) ±1-2 kV; (vii) ±2-3 kV; (viii) ±3-4 kV; (ix) ±4-5 kV; (x) ±5-6 kV; (xi) ±6-7 kV; (xii) ±7-8 kV; (xiii) ±8-9 kV; (xiv) ±9-10 kV; and (xv) >±10 kV.

The mask or shield is preferably attached to or otherwise provided on a rear surface of the first microchannel plate device. The mask or shield is preferably attached to or otherwise provided on a front surface of the second microchannel plate device. According to an embodiment the mask or shield is attached to or otherwise provided on a rear surface of the first microchannel plate device and is attached to or otherwise provided on a front surface of the second microchannel plate device.

The mask or shield preferably comprises a material selected from the group consisting of: (i) a metal; (ii) a plastic; (iii) a ceramic; (iv) a conductor; (v) an insulator; (vi) a semiconductor; (vii) a thin film; (viii) an organic layer; (ix) an inorganic layer; (x) a polyimide layer; (xi) a thermoplastic layer; and (xii) Kapton (RTM).

The first microchannel plate device preferably comprises a front surface upon which ions are received in use and a rear surface from which electrons are emitted in use and wherein the second microchannel plate device comprises a front surface upon which electrons emitted from the first microchannel plate device are received in use and a rear surface from which electrons are emitted in use.

The separation between the rear surface of the first microchannel plate device and the front surface of the second microchannel plate device is preferably selected from the group consisting of: (i) <1 μm; (ii) 1-5 μm; (iii) 5-10 μm; (iv) 10-15 μm; (v) 15-20 μm; (vi) 20-25 μm; (vii) 25-30 μm; (viii) 30-35 μm; (ix) 35-40 μm; (x) 40-45 μm; (xi) 45-50 μm; (xii) 50-55 μm; (xiii) 55-60 μm; (xiv) 60-65 μm; (xv) 65-70 μm; (xvi) 70-75 μm; (xvii) 75-80 μm; (xviii) 80-85 μm; (xix) 85-90 μm; (xx) 90-95 μm; (xxi) 95-100 μm; and (xxii) >100 μm.

According to an embodiment the separation between the rear surface of the second microchannel plate device and a front surface of the first collection anode is selected from the group consisting of: (i) <1 μm; (ii) 1-10 μm; (iii) 10-20 μm; (iv) 20-30 μm; (v) 30-40 μm; (vi) 40-50 μm; (vii) 50-60 μm; (viii) 60-70 μm; (ix) 70-80 μm; (x) 80-90 μm; (xi) 90-100 μm; (xii) 100-120 μm; (xiii) 120-140 μm; (xiv) 140-160 μm; (xv) 160-180 μm; (xvi) 180-200 μm; (xvii) 200-250 μm; (xviii) 250-300 μm; (xix) 300-350 μm; (xx) 350-400 μm; (xxi) 400-450 μm; (xxii) 450-500 μm; and (xxiii) >500 μm.

According to an embodiment the separation between the rear surface of the second microchannel plate device and a front surface of the second collection anode is selected from the group consisting of: (i) <1 μm; (ii) 1-10 μm; (iii) 10-20 μm; (iv) 20-30 μm; (v) 30-40 μm; (vi) 40-50 μm; (vii) 50-60 μm; (viii) 60-70 μm; (ix) 70-80 μm; (x) 80-90 μm; (xi) 90-100 μm; (xii) 100-120 μm; (xiii) 120-140 μm; (xiv) 140-160 μm; (xv) 160-180 μm; (xvi) 180-200 μm; (xvii) 200-250 μm; (xviii) 250-300 μm; (xix) 300-350 μm; (xx) 350-400 μm; (xxi) 400-450 μm; (xxii) 450-500 μm; and (xxiii) >500 μm.

Preferably, the first collection anode is substantially larger than the second collection anode. The first collection anode preferably has a first active electron detecting area and the second collection anode has a second active electron detecting area, wherein the ratio of the first active electron detecting area to the second active electron detecting area is selected from the group consisting of: (i) <1; (ii) 1-1.5; (iii) 1.5-2.0; (iv) 2-3; (v) 3-4; (vi) 4-5; (vii) 5-6; (viii) 6-7; (ix) 7-8; (x) 8-9; (xi) 9-10; (xii) 10-15; (xiii) 15-20; (xiv) 20-25; (xv) 25-30; (xvi) 30-35; (xvii) 35-40; (xviii) 40-45; (xix) 45-50; (xx) 50-60; (xxi) 60-70; (xxii) 70-80; (xxiii) 80-90; (xxiv) 90-100; (xxv) 100-150; (xxvi) 150-200; (xxvii) 200-250; (xxviii) 250-300; (xxix) 300-350; (xxx) 350-400; (xxxi) 400-450; (xxxii) 450-500; and (xxxiii) >500.

According to an embodiment the first and second collection anodes are substantially co-planar. According to a less preferred embodiment the first and second collection anodes are not substantially co-planar.

Preferably, the first collection anode substantially encloses, surrounds or envelopes the second collection anode. According to an embodiment the second collection anode is provided in a slot, channel, slit, aperture or window within the first collection anode or formed by the first collection anode. Preferably, the size of the slot, channel, slit, aperture or window within the first collection anode or formed by the first collection anode is substantially greater or larger than the size, area, diameter, length or width of the second collection anode.

The first collection anode preferably comprises one or more collection anodes. The first collection anode may comprise an array of collection anodes. The second collection anode preferably comprises one or more collection anodes. The second collection anode may comprise an array of collection anodes.

According to an embodiment the ion detector preferably comprises one or more Time to Digital Converters (“TDC”) connected to the first collection anode. According to an embodiment the ion detector preferably one or more Analogue to Digital Converters (“ADC”) connected to the first collection anode.

According to an embodiment the ion detector preferably comprises one or more Time to Digital Converters (“TDC”) connected to the second collection anode. According to an embodiment the ion detector preferably one or more Analogue to Digital Converters (“ADC”) connected to the second collection anode.

According to an aspect of the present invention there is provided an analytical instrument comprising an ion detector as described.

According to an aspect of the present invention there is provided a mass analyser comprising an ion detector as described above.

According to an aspect of the present invention there is provided a mass spectrometer comprising an ion detector as described above.

The mass spectrometer preferably further comprises a mass analyser. The mass analyser is preferably selected from the group consisting of: (i) an orthogonal acceleration Time of Flight mass analyser; (ii) an axial acceleration Time of Flight mass analyser; (iii) a Paul 3D quadrupole ion trap mass analyser; (iv) a 2D or linear quadrupole ion trap mass analyser; (v) a Fourier Transform Ion Cyclotron Resonance mass analyser; (vi) a magnetic sector mass analyser; (vii) a quadrupole mass analyser; and (viii) a Penning trap mass analyser.

The mass spectrometer or other analytical instrument preferably further comprises an ion source. The ion source may be either a pulsed ion source or a substantially continuous ion source. The ion source is preferably selected from the group consisting of: (i) an Electrospray ionisation (“ESI”) ion source; (ii) an Atmospheric Pressure Photo Ionisation (“APPI”) ion source; (iii) an Atmospheric Pressure Chemical Ionisation (“APCI”) ion source; (iv) a Matrix Assisted Laser Desorption Ionisation (“MALDI”) ion source; (v) a Laser Desorption Ionisation (“LDI”) ion source; (vi) an Atmospheric Pressure Ionisation (“API”) ion source; (vii) a Desorption Ionisation on Silicon (“DIOS”) ion source; (viii) an Electron Impact (“EI”) ion source; (ix) a Chemical Ionisation (“CI”) ion source; (x) a Field Ionisation (“FI”) ion source; (xi) a Field Desorption (“FD”) ion source; (xii) an Inductively Coupled Plasma (“ICP”) ion source; (xiii) a Fast Atom Bombardment (“FAB”) ion source; (xiv) a Liquid Secondary Ion Mass Spectrometry (“LSIMS”) ion source; (xv) a Desorption Electrospray Ionisation (“DESI”) ion source; and (xvi) a Nickel-63 radioactive ion source.

According to another aspect of the present invention there is provided a method of detecting ions comprising:

directing ions on to an ion detector comprising a first microchannel plate device, a second microchannel plate device and a mask or shield provided intermediate between the first microchannel plate device and second microchannel plate device;

detecting electrons emitted from the second microchannel plate device using at least a first collection anode and a second separate collection anode, the first collection anode having a first active electron detecting area or size and the second collection anode having a second different active electron detecting area or size, and the first collection anode and the second collection anode arranged downstream of the second microchannel plate device.

According to an aspect of the present invention there is provided a method of mass spectrometry comprising the method of detecting ions as described above.

According to an aspect of the invention there is provided an ion detector comprising:

a first microchannel plate device;

a second microchannel plate device; and

a mask or shield provided intermediate between the first microchannel plate device and second microchannel plate device, wherein the separation between the first microchannel plate device and second microchannel plate device is ≦50 μm.

According to an aspect of the invention there is provided an ion detector comprising:

a first microchannel plate device;

a second microchannel plate device;

a mask or shield provided intermediate between the first microchannel plate device and second microchannel plate device, wherein the mask or shield comprises an insulator.

According to an embodiment the mask or shield comprises a material selected from the group consisting of: (i) a plastic; (ii) a ceramic; (iii) a thin film; (iv) an organic layer; (v) an inorganic layer; (vi) a polyimide layer; (vii) a thermoplastic layer; and (viii) Kapton (RTM).

According to an aspect of the invention there is provided an ion detector comprising:

a first microchannel plate device;

a second microchannel plate device; and

a mask or shield provided intermediate between the first microchannel plate device and second microchannel plate device.

The preferred embodiment relates to a microchannel plate detector assembly comprising two or more microchannel plates and two or more collection anodes. A mask is placed between the two microchannel plates such that all the electrons in an electron cloud emerging from the second downstream microchannel plate, due to an ion striking the first upstream microchannel plate only strike one of the two collection anodes. The separation between the microchannel plates is preferably 50 μm or less.

The collection anodes preferably have unequal electron detecting areas although according to a less preferred embodiment the two or more collection anodes may have substantially the same area. The mask shape and size is preferably such that it at least masks the boundary between two collection anodes so that an ion incident on the input face of a first microchannel plate does not result in an electron cloud emerging from the second microchannel plate wherein only some of the electrons strike one collection anode. In a preferred embodiment the mask comprises an insulator.

In a preferred embodiment one or more of the collection anodes in the ion detector are preferably used in conjunction with an amplifier, a discriminator and a fast event counter for the purpose of counting ions.

The preferred ion detector is preferably used in a Time of Flight mass spectrometer incorporating a Time to Digital Converter (TDC) to detect ions and record their arrival times. The preferred ion detector preferably exhibits an extended dynamic range for quantification applications and/or mass measurement applications.

Various embodiments of the present invention will now be described, by way of example only, together with other arrangements given for illustrative purposes only and with reference to the accompanying drawings in which:

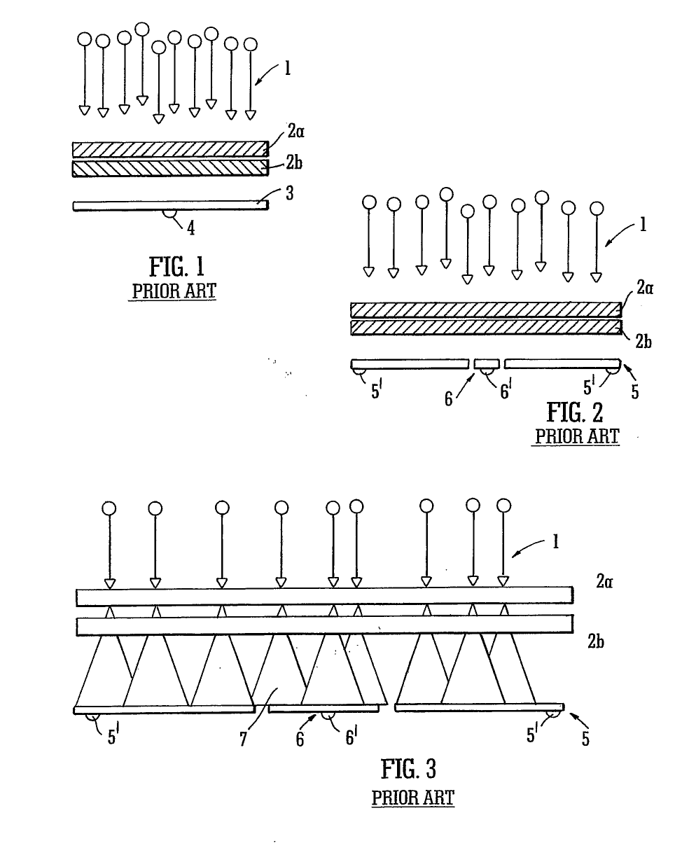

FIG. 1 shows a known ion detector comprising a pair of microchannel plates and a single collection anode;

FIG. 2 shows another known ion detector comprising a pair of microchannel plate plates and two different sized collection anodes arranged to collect different fractions of secondary electrons emitted from the second rearmost microchannel plate;

FIG. 3 shows in greater detail the arrangement shown in FIG. 2 and illustrates how in the known arrangement an ion arriving at the ion detector may result in a cloud of secondary electrons being emitted from the second microchannel plate which impinges across both collection anodes;

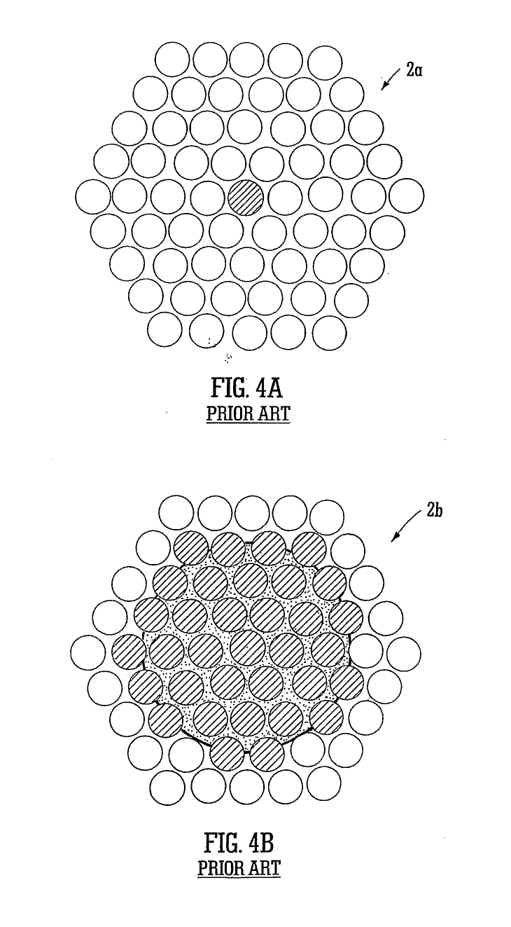

FIG. 4A illustrates a channel in the first microchannel plate activated by an ion arriving at the first microchannel plate and FIG. 4B shows the corresponding channels energised in the second microchannel plate due to a cloud of electrons being emitted from the first microchannel plate;

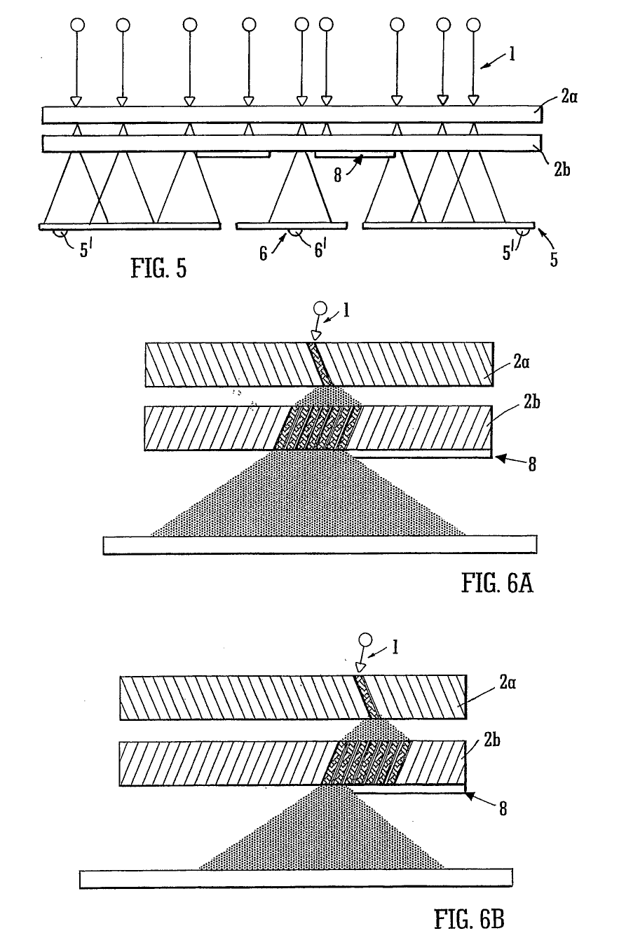

FIG. 5 shows an arrangement wherein a mask is provided on the rear surface of the second microchannel plate;

FIG. 6A shows in greater detail how with the arrangement shown in FIG. 5 an ion arriving at the first microchannel plate causes a cloud of electrons to be emitted from the second microchannel plate and FIG. 6B shows in greater detail how an ion arriving at a different position on the first microchannel plate in the arrangement shown in FIG. 5 causes secondary electrons to be produced with the second microchannel plate but only some of these electrons are emitted from the second microchannel plate due to being blocked by the mask;

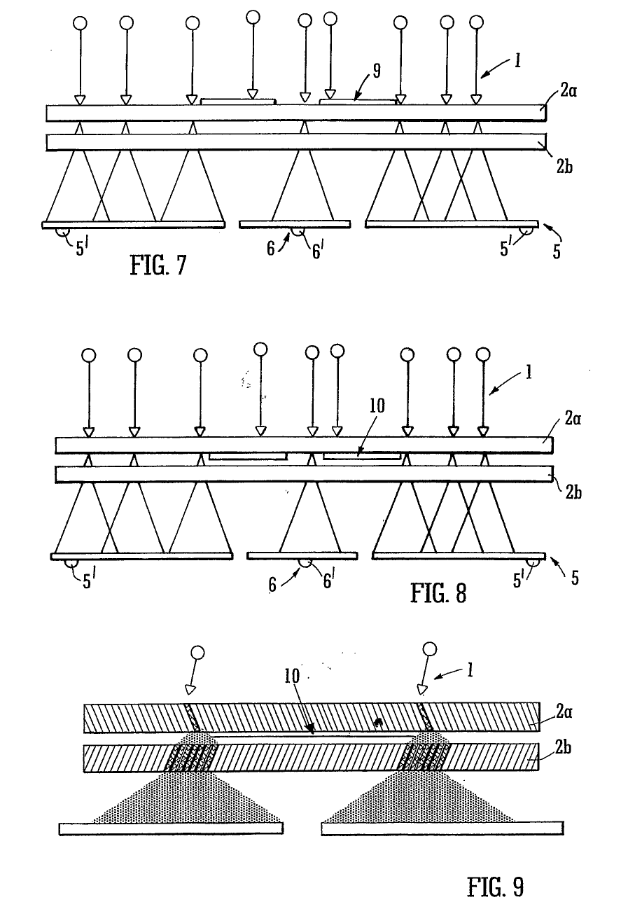

FIG. 7 shows an arrangement wherein a mask is provided on the front surface or face of the first microchannel plate;

FIG. 8 shows a preferred embodiment of the present invention wherein a mask is provided between the two microchannel plates; and

FIG. 9 shows in greater detail how the mask according to the preferred embodiment as shown in FIG. 8 prevents a cloud of secondary electrons from being emitted from the second microchannel plate which either impinges upon two collection anodes or which can vary in intensity.

A known microchannel plate ion detector is shown in FIG. 1. Such an ion detector may be in incorporated in a Time of Flight mass spectrometer. Ions 1 are arranged to fall incident upon the input face or front surface of a stack of two microchannel plates 2a,2b. Secondary electrons are emitted from the first microchannel plate 2a and are subsequently amplified by the second microchannel plate 2b which is arranged downstream of the first microchannel plate.

Pulses of secondary electrons or clouds of secondary electrons exit or emerge from the second microchannel plate 2b and strike the single collection anode 3. The pulse of secondary electrons received by the collection anode 3 is then amplified and subsequently recorded using a Time to Digital Converter (“TDC”) connected to the collection anode 3 at location 4.

FIG. 1 in particular illustrates a single instance in time wherein ten ions arrive substantially simultaneously at the ion detector. However, although ten ions arrive at the ion detector the Time to Digital Converter connected to the single collection anode 3 will only record a single event or ion arrival event.

It is for this reason that improved ion detectors are known comprising two collection anodes. FIG. 2 illustrates such a known ion detector which comprises two separate collection anodes 5,6 having unequal areas. In the particular example shown in FIG. 2 the first larger collection anode 5 collects electron pulses resulting from 90% of the ions arriving at the input face of the first microchannel plate 2a. Therefore, 90% of the ions 1 arriving at the first microchannel plate 2a will yield electron clouds which will strike the larger collection anode 5 whilst only 10% of the ions 1 arriving at the first microchannel plate will yield electron clouds which will strike the smaller second collection anode 6.

A first Time to Digital Converter 5′ is shown connected to the larger collection anode 5 and will only record one ion arrival event. However, a second Time to Digital Converter 6′ is shown connected to the smaller collection anode 6 and will in addition record one ion arrival event.

Over many measurements the first Time to Digital Converter 5′ may persistently record one event whereas the second Time to Digital Converter 6′ may sometimes record no event and sometimes record one event.

If the output from the first Time to Digital Converter 5′ is recognised as being in error due, for example, to showing signs of being saturated, then the signal recorded by the second Time to Digital Converter 6′ may then be used to estimate the total signal arriving at the ion detector if the ratio of the collection fractions for the two collection anodes 5,6 is known. Therefore using two different sized collection anodes 5,6 allows the dynamic range of the ion detector to be increased.

FIG. 3 shows in greater detail the known ion detector as shown in FIG. 2. In particular, FIG. 3 shows the electron clouds emitted from the first and second microchannel plates 2a,2b. FIG. 3 illustrates how an electron cloud emitted from the first microchannel plate 2a spreads out and has a larger footprint or area on the input or incident surface of the second microchannel plate 2b. FIG. 3 also illustrates how in a similar manner electron clouds emitted from the exit surface of the second microchannel plate 2b spread out and may impinge on the first collection anode 5 and/or the second collection anode 6.

The diameter Dc of an electron cloud emerging from a single channel of a microchannel plate at a distance S from the exit face of that microchannel plate is given by:

$$Dc = d + \frac{4 \times S \times sin φ \times cos φ \times E}{Vb} \times ( \sqrt{1 + \frac{Vb}{E \times cos {φ}^{2}}} - 1 )$$

$$where \text{:}$$

$$φ = {tan}^{- 1} ( \frac{d}{p} )$$

and wherein E is the mean exit energy of electrons leaving the microchannel plate, S is the distance from the exit face of the microchannel plate, Vb is the voltage difference across the distance S, d is the diameter of a single microchannel plate channel and p is the depth of penetration of the electrode material into the microchannel plate channels at the exit of the microchannel plate (end spoiling).

In order to further illustrate the arrangement shown in FIG. 3, a stack of two microchannel plates can be considered. The two microchannel plates can be considered provided in a chevron arrangement in which individual channel diameters d are 10 μm, the end spoiling p is 10 μm, the channel pitch is 12 μm and the inter-plate gap is 25 μm. A microchannel plate operating plate bias of 1000 V per plate may be assumed and the mean energy E of electrons leaving the microchannel plate may be determined as being approximately 35 eV.

For a single ion arriving at the input face of the first microchannel plate 2a shown in FIG. 3, the resulting electron cloud exiting the first microchannel plate 2a will have spread to a diameter of approximately 60 μm upon striking the input face of the second microchannel plate 2b. This corresponds to illuminating approximately 23 channels of the second microchannel plate 2b. This is illustrated further in FIGS. 4A and 4B.

FIG. 4A shows the first microchannel plate 2a with a single channel (shown shaded) being energised by the arrival of an ion. FIG. 4B shows the second microchannel plate 2b and those channels energised (shown shaded) by secondary electrons exiting from the single channel in the first microchannel plate 2a diverging so as to illuminate a greater number of channels in the second microchannel plate 2b.

If the gap between the exit face of the second microchannel plate 2b and the first and second collection anodes 5,6 is taken to be 0.5 mm, and the bias voltage between the exit face of the second microchannel plate 2b and the first and second collection anodes 5,6 is set at 100 V then the diameter of the cloud of electrons from each channel of the second microchannel plate will be approximately 0.6 mm. Therefore, the overall diameter of the cloud of electrons emerging from the group of 23 channels of the second microchannel plate 2b will be approximately 0.7 mm. In practice, the overall diameter of the electron cloud is likely to be even greater due to space charge repulsion between electrons.

Referring back to FIG. 3 it can be seen that with the conventional arrangement as illustrated one of the ions incident upon the first microchannel plate 2a yields an electron cloud 7 that is shared between both the first and second collection anodes 5,6. It is apparent therefore that a single ion arriving at the ion detector can result in secondary electrons impinging upon both collection anodes 5,6. Consequently, this ion may either fail to be counted entirely or may be counted once or twice. The outcome will be dependent largely upon the electron amplification factor for each ion in the microchannel plate electron multipliers, the position of the ion, and the amplifier and discriminator settings.

FIG. 5 shows the effect of placing a mask 8 on the rear surface of the second microchannel plate 2b. The mask 8 is shown positioned so as to screen the boundary region between the two collection anodes 5,6 from the second microchannel plate 2b. The mask 8 is intended to prevent an electron cloud from exiting from the second microchannel plate 2b and from being shared between the first and second anodes 5,6. The arrangement shown in FIG. 5 may be effective in preventing an electron cloud being shared across the two collection anodes 5,6 but the arrangement suffers from another problem as will be described in more detail below.

FIG. 6A shows how an ion impinging upon a certain position on the first microchannel plate 2a may generate a cloud of electrons which is substantially unaffected by the mask 8 i.e. the intensity of the cloud of electrons may be 100%. FIG. 6B shows the situation when an ion impinges upon a different position on the first microchannel plate 2a. As shown in FIG. 6B, the mask may reduce the intensity of a cloud of electrons emitted from the second microchannel plate 2b in certain circumstances i.e. the intensity of the cloud of electrons emitted from the second microchannel plate 2b may be much less than 100%.

As can be seen from FIG. 6B, the mask 8 can partially block electrons from leaving the second microchannel plate 2b and hence reaching one of the collection anodes 5,6. Accordingly, placement of a mask 8 on the rear surface of the second microchannel plate 2b causes the problem that in certain circumstances an ion may or may not be counted due to the fact the intensity of the electron cloud emitted from the second microchannel plate 2b may be too low to trigger the ion detector to record an ion arrival event.

FIG. 7 shows an arrangement wherein a mask 9 is placed instead on the front surface of the first microchannel plate 2a. According to this arrangement the mask 9 is positioned such that ions which would otherwise result in an electron cloud being emitted from the second microchannel plate falling incident upon both the first and second collision anodes 5,6 are blocked by the mask 9. However, this arrangement suffers from a number of potential problems. Ions arriving at the ion detector and approaching the first microchannel plate 2a as shown in FIG. 7 can strike the edge of the mask 9 thereby yielding secondary electrons which may then be amplified and detected and which will give rise to ghost peaks in the resultant mass spectrum.

Another problem is that if the ion detector as shown in FIG. 7 were to be used as a post acceleration ion detector, then the mask 9 would also introduce a distortion in or to the electric field. This could cause ions to be deflected and to arrive at the ion detector at different times. This would produce broadening of the mass peak in the resultant mass spectrum.

The provision of a mask 9 in front of the first microchannel plate 2a is also problematic in that it will be bombarded with ions and will therefore become coated with insulating material which will hold a charge. This can therefore disturb the flight path and ion arrival times.

A yet further problem is that ion bombardment of the mask 9 can also cause sputtering of secondary atoms and ions, some of which may then be subsequently detected by the ion detector giving rise to ghost peaks in the resultant mass spectrum.

FIG. 8 shows a preferred embodiment of the present invention and at least in the preferred implementation does not substantially suffer from the problems associated with conventional ion detectors or the other arrangements contemplated and described above. According to the preferred embodiment an ion detector assembly is provided comprising at least two microchannel plates 2a,2b and preferably at least a first collection anode 5 and a second collection anode 6. The first and second collection anodes 5,6 are preferably co-planar, but this is not essential.

According to the preferred embodiment a mask 10 is preferably situated or otherwise positioned between the first and second microchannel plates 2a,2b. The mask 10 may be attached to the rear surface of the first microchannel plate 2a or to the front surface of the second microchannel plate 2b. According to a particularly preferred embodiment the mask is sandwiched between the first microchannel plate 2a and the second microchannel plate 2b.

The shape, size and position of the mask 10 is preferably such as to align it with the boundaries between the first and second collection anodes 5,6. Any electron cloud which would otherwise emerge from the first microchannel plate 2a as a result of an ion arrival and which would otherwise result in an electron cloud being emitted from the second microchannel plate 2b which would be shared between the first and second collection anodes 5,6 is preferably substantially prevented from reaching the second microchannel plate 2b by the mask 10. In this way the problem of shared electrons between the two collection anodes 5, 6 is preferably substantially eliminated or at least significantly reduced.

The preferred embodiment as shown in FIG. 8 also preferably substantially solves the problem of electron clouds being emitted from the second microchannel plate 2b which can vary significantly in intensity. FIG. 9 shows an enlarged portion of the ion detector according to the preferred embodiment as illustrated in FIG. 8. The mask 10 is shown positioned so as to prevent an electron cloud due to an ion arriving at the ion detector being shared between two collection anodes. The mask 10 also advantageously does not give rise to a situation wherein only a reduced fraction of secondary electrons reach a particular collection anode which could otherwise result in an ion arrival event being missed.

Advantageously, according to the preferred embodiment the mask 10 also does not stand proud of the input surface of the first microchannel 2a of the ion detector. Accordingly, the mask 10 is not exposed to ion bombardment and all the undesirable consequences associated therewith as discussed above with reference to the arrangement shown in FIG. 7.

According to the preferred embodiment the thickness of the mask 10 is preferably as small as possible to avoid unnecessary spreading in the diameter of the electron cloud incident upon the input surface of the second microchannel plate 2b. The mask 10 may, for example, have a thickness less than or equal to 25 μm. For a mask thickness of 25 μm the inter-plate gap is preferably not significantly increased.

The ion detector according to the preferred embodiment is preferably applicable to systems using a combination of ADC and TDC detectors with one or more collection anodes.

An embodiment of the present invention is contemplated wherein the ion detector consists of a stack of more than two microchannel plates. It is also contemplated that the microchannel plates 2a,2b may be of equal size or may alternatively be of unequal size. In the case where more than the mask 10 is preferably between the initial two microchannel plates.

According to an embodiment the larger collection anode 5 may have a circular hole provided in it in which a smaller circular collection anode 6 may protrude or otherwise be provided. Alternatively, a rectangular slot may be provided in the larger collection anode 5 through which a smaller rectangular collection anode 6 may protrude or otherwise be provided. Various alternative embodiments are also contemplated including embodiments wherein the smaller collection anode 6 is not in the same plane as the larger collection anode 5.

According to further embodiments multiple smaller collection anodes may be employed. The multiple smaller collection anodes may be of equal area and/or shape. Alternatively, the multiple smaller collection anodes may have unequal areas and/or shapes.

Although the present invention has been described with reference to preferred embodiments, it will be understood by those skilled in the art that various changes in form and detail may be made without departing from the scope of the invention as set forth in the accompanying claims.

1. An ion detector comprising:
a first microchannel plate device;
a second microchannel plate device;
a mask or shield provided intermediate between said first microchannel plate device and second microchannel plate device; and
at least a first collection anode having a first active electron detecting area or size and a second separate collection anode having a second different active electron detecting area or size arranged downstream of said second microchannel plate device.

2. An ion detector as claimed in claim 1, wherein said first microchannel plate device comprises one, two or more than two microchannel plates.

3. An ion detector as claimed in claim 1, wherein said second microchannel plate device comprises one, two or more than two microchannel plates.

4. An ion detector as claimed in claim 1, wherein said mask or shield is arranged to block, attenuate, at least partially attenuate or divert electrons emitted from said first microchannel plate device.

5. An ion detector as claimed in claim 1, wherein said mask or shield substantially prevents electrons exiting from or emerging from said first microchannel plate device and/or from impinging upon or arriving at said second microchannel plate device.

6. An ion detector as claimed in claim 1, wherein said mask or shield is arranged such that at least some ions arriving at said first microchannel plate device at certain locations or positions on said first microchannel plate device are either: (a) substantially prevented from subsequently causing a cloud of secondary electrons to be emitted from said second microchannel plate device; or (b) subsequently cause a cloud of secondary electrons to be emitted from said second microchannel plate device which either substantially impinge upon said first collection anode or upon said second collection anode but wherein the cloud of secondary electrons emitted from said second microchannel plate device do not substantially impinge simultaneously upon both said first collection anode and said second collection anode.

7. An ion detector as claimed in claim 1, wherein said mask or shield is arranged such that ions arriving at said first microchannel plate device: (i) do not substantially result in a cloud of secondary electrons being produced which impinges simultaneously upon both said first collection anode and said second collection anode; or (ii) result either in a cloud of secondary electrons which impinges upon said first collection anode or upon said second collection anode but not upon both said first and second collection anodes simultaneously.

8. (canceled)

9. An ion detector as claimed in claim 1, wherein said mask or shield has a thickness selected from the group consisting of: (i) <1 μm; (ii) 1-5 μm; (iii) 5-10 μm; (iv) 10-15 μm; (v) 15-20 μm; (vi) 20-25 μm; (vii) 25-30 μm; (viii) 30-35 μm; (ix) 35-40 μm; (x) 40-45 μm; (xi) 45-50 μm; (xii) 50-55 μm; (xiii) 55-60 μm; (xiv) 60-65 μm; (xv) 65-70 μm; (xvi) 70-75 μm; (xvii) 75-80 μm; (xviii) 80-85 μm; (xix) 85-90 μm; (xx) 90-95 μm; (xxi) 95-100 μm; and (xxii) >100 μm.

10-22. (canceled)

23. An ion detector as claimed in claim 1, wherein said mask or shield is attached to or otherwise provided on a rear surface of said first microchannel plate device and is attached to or otherwise provided on a front surface of said second microchannel plate device.

24. An ion detector as claimed in claim 1, wherein said mask or shield comprises a material selected from the group consisting of: (i) a metal; (ii) a plastic; (iii) a ceramic; (iv) a conductor; (v) an insulator; (vi) a semiconductor; (vii) a thin film; (viii) an organic layer; (ix) an inorganic layer; (x) a polyimide layer; (xi) a thermoplastic layer; and (xii) Kapton (RTM).

25. (canceled)

26. An ion detector as claimed in claim 1, wherein the separation between said rear surface of said first microchannel plate device and the front surface of said second microchannel plate device is selected from the group consisting of: (i) <1 μm; (ii) 1-5 μm; (iii) 5-10 μm; (iv) 10-15 μm; (v) 15-20 μm; (vi) 20-25 μm; (vii) 25-30 μm; (viii) 30-35 μm; (ix) 35-40 μm; (x) 40-45 μm; (xi) 45-50 μm; (xii) 50-55 μm; (xiii) 55-60 μm; (xiv) 60-65 μm; (xv) 65-70 μm; (xvi) 70-75 μm; (xvii) 75-80 μm; (xviii) 80-85 μm; (xix) 85-90 μm; (xx) 90-95 μm; (xxi) 95-100 μm; and (xxii) >100 μm.

27-29. (canceled)

30. An ion detector as claimed in claim 1, wherein the ratio of said first active electron detecting area or size to said second active electron detecting area or size is selected from the group consisting of: (i) <1; (ii) 1-1.5; (iii) 1.5-2.0; (iv) 2-3; (v) 3-4; (vi) 4-5; (vii) 5-6; (viii) 6-7; (ix) 7-8; (x) 8-9; (xi) 9-10; (xii) 10-15; (xiii) 15-20; (xiv) 20-25; (xv) 25-30; (xvi) 30-35; (xvii) 35-40; (xviii) 40-45; (xix) 45-50; (xx) 50-60; (xxi) 60-70; (xxii) 70-80; (xxiii) 80-90; (xxiv) 90-100; (xxv) 100-150; (xxvi) 150-200; (xxvii) 200-250; (xxviii) 250-300; (xxix) 300-350; (xxx) 350-400; (xxxi) 400-450; (xxxii) 450-500; and (xxxiii) >500.

31-32. (canceled)

33. An ion detector as claimed in claim 1, wherein said first collection anode substantially encloses, surrounds or envelopes said second collection anode.

34. An ion detector as claimed in claim 1, wherein said second collection anode is provided in a slot, channel, slit, aperture or window within said first collection anode or formed by said first collection anode.

35-36. (canceled)

37. An ion detector as claimed in claim 1, wherein said first collection anode and/or said second collection anode comprises an array of collection anodes.

38-39. (canceled)

40. An ion detector as claimed in claim 1, further comprising one or more Time to Digital Converters (“TDC”) and/or one or more Analogue to Digital Converters (“ADC”) connected to said first collection anode.

41. (canceled)

42. An ion detector as claimed in claim 1, further comprising one or more Time to Digital Converters (“TDC”) and/or one or more Analogue to Digital Converters (“ADC”) connected to said second collection anode.

43. (canceled)

44. An analytical instrument comprising an ion detector as claimed in claim 1.

45. A mass analyser comprising an ion detector as claimed in claim 1.

46. A mass spectrometer comprising an ion detector as claimed in claim 1.

47. A mass spectrometer as claimed in claim 46, further comprising a mass analyser.

48. A mass spectrometer as claimed in claim 47, wherein said mass analyser is selected from the group consisting of: (i) an orthogonal acceleration Time of Flight mass analyser; (ii) an axial acceleration Time of Flight mass analyser; (iii) a Paul 3D quadrupole ion trap mass analyser; (iv) a 2D or linear quadrupole ion trap mass analyser; (v) a Fourier Transform Ion Cyclotron Resonance mass analyser; (vi) a magnetic sector mass analyser; (vii) a quadrupole mass analyser; and (viii) a Penning trap mass analyser.

49. A mass spectrometer as claimed in claim 46, further comprising an ion source selected from the group consisting of: (i) an Electrospray ionisation (“ESI”) ion source; (ii) an Atmospheric Pressure Photo Ionisation (“APPI”) ion source; (iii) an Atmospheric Pressure Chemical Ionisation (“APCI”) ion source; (iv) a Matrix Assisted Laser Desorption Ionisation (“MALDI”) ion source; (v) a Laser Desorption Ionisation (“LDI”) ion source; (vi) an Atmospheric Pressure Ionisation (“API”) ion source; (vii) a Desorption Ionisation on Silicon (“DIOS”) ion source; (viii) an Electron Impact (“EI”) ion source; (ix) a Chemical Ionisation (“CI”) ion source; (x) a Field Ionisation (“FI”) ion source; (xi) a Field Desorption (“FD”) ion source; (xii) an Inductively Coupled Plasma (“ICP”) ion source; (xiii) a Fast Atom Bombardment (“FAB”) ion source; (xiv) a Liquid Secondary Ion Mass Spectrometry (“LSIMS”) ion source; (xv) a Desorption Electrospray Ionisation (“DESI”) ion source; and (xvi) a Nickel-63 radioactive ion source.

50. A method of detecting ions comprising:
directing ions on to an ion detector comprising a first microchannel plate device, a second microchannel plate device and a mask or shield provided intermediate between said first microchannel plate device and second microchannel plate device;
detecting electrons emitted from the second microchannel plate device using at least a first collection anode and a second separate collection anode, said first collection anode having a first active electron detecting area or size and said second collection anode having a second different active electron detecting area or size, and said first collection anode and said second collection anode arranged downstream of said second microchannel plate device.

51. A method of mass spectrometry comprising the method of detecting ions as claimed in claim 50.

52-55. (canceled)
